(19) United States
(12) Patent Application Publication
(10) Pub. No.: US 2008/0301296 A1
(43) Pub. Date: Dec. 4, 2008

(54) System and method for creating, tracking and analyzing tasks

(76) Inventor: Jeremy Dwayne York, Loganville, GA (US)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 11/809,119

(22) Filed: May 30, 2007

(51) Int. Cl. G06F 15/16

(52) U.S. Cl. 709/225

(57) ABSTRACT

A system and method for creating, negotiating, tracking, and analyzing tasks, wherein the present invention provides for automated negotiation of tasks between task assignor and task assignee, and wherein the present invention provides for automated tracking and trending of task completion, performing statistical analysis of the task status and task completion, tracking and trending of tasks assigned to an individuals or group of individuals, sets of individuals belonging to a department or organization, tracking and trending groups of tasks making up a project, and tracking and trending of tasks across an entire organization.

### COPYRIGHT NOTICE

A portion of the disclosure of this patent document contains material which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### FIELD OF THE INVENTION

The present invention relates generally to automating a process for managing tasks and more specifically to a system and method for providing automated task creation and delegation, and an analysis tool and for processing task information and data.

### BACKGROUND OF THE INVENTION

A recent Harvard Business School study concluded that an average employee retains approximately 33-50% of what he or she has learned on the job and accomplishes approximately 33-50% of the tasks he or she is delegated to accomplish in a normal business day.

As human beings become increasingly busy the list of tasks each person needs to keep track of grows to a point where one looks for assistance in keeping track of their tasks. In pre-computer times, task management was limited to handwritten notes or systems often maintained on a calendar or in a paper based organizer. With the advent of the personal computers, PDAs and cell phones, and with such devices operating computer software, such a device can be configured to assist a user with organizing tasks. For example, the Microsoft Corporation offers for sale a computer program known as OUTLOOK (TM) that operates on such devices wherein a user can create and manage a task. A task, as defined by Microsoft, is a personal or work-related errand you want to track through completion. Such tasks can occur once or repeatedly as in a recurring task. A recurring task can repeat at regular intervals or repeat based on the date you mark the task complete.

In particular, a task is created within OUTLOOK (TM) by clicking the “Tasks” menu bar in OUTLOOK (TM) and then clicking “Click here to add a new Task.” A user then types in a description of the task in text form under “Subject” and assigns the task a due date by clicking on a date within a pop-up calendar. Moreover, a user clicks a drop down window to add due date, start date, status, priority, % complete, reminder dates and times, and assign an owner to the task. Still further, under a “Details” tab a user inputs additional information regarding the task such as date completed, total work in hours, actual work in hours, mileage, billing information, and companies.

In addition to a user creating their own tasks, a user can create tasks that are assigned to others. A user (sender) performs this function by sending a task request to another user in the system (recipient). The system sends the request for example via an e-mail message asking the recipient to complete the task specified by the sender. The recipient who receives the task request becomes the temporary owner of the task. The recipient can decline the task, accept the task, or assign the task to someone else. If the recipient declines the task, the task is returned to the sender and re-appears in the task list of the sender. If the recipient accepts the task, it is added to the recipient's task list, and the recipient becomes the new owner of the task. If the recipient assigns the task to someone else, the new assignee becomes the temporary owner of the task. When the owner completes the task and marks the task complete, OUTLOOK (TM) sends a status report to the sender who originally assigned the task, any other prior owners, and anyone else who requested a report of the task completion.

Although the foregoing software tool allows a user to create, describe, assign, create a task due date, start date, status, priority, percentage completes set reminder dates and times, and assign an owner to the task such a system presents significant disadvantages to the user. Such as, an assignee of a task is not given the opportunity to negotiate with the task creator the performance of the task nor the terms of performing and/or completing the task; nor does such a system or method provide feedback to the user in relation to multiple task, managerial feedback regarding individuals performing tasks, sets of individuals, sets of individuals belonging to a department or organization, or feedback from across the entire organization regarding tasks or groups of tasks making up a project. Specifically, such software does not enable the user to track cumulative percentages over all tasks assigned to the user or a subsets of task assigned to the user nor enable a manager to trend or track task completion or perform statistical analysis of individuals, sets of individuals, sets of individuals belonging to a department or organization, or feedback from across the entire organization regarding tasks or groups of tasks making up a project.

Furthermore, project planning and review software is available wherein a project manager or project team using such software is assisted with the management of planning, re-planning and reviewing projects, including resource analysis, work-breakdown, review of hours and e-mail updates, and resource needs analysis. Additionally such software allows a project manager or project team to re-plan a project that is running late. It provides a target date calculation that displays how much time still needs to be taken off of the tasks in the project to meet the target re-plan date and allows the tasks to be edited to reflect those new commitments. Project planning software includes tools for supervisors and senior management to determine the workload of employees, how employee resources are being allocated, whether the allocation of personnel resources is optimum, how to improve employee productivity, and whether employees are making progress toward organizational goals.

Unfortunately, many current project management systems require much customization to “fit” the system to the type of business or product/service. This customization means many hours of consultant analysis and custom software programming. Furthermore, such customization is expensive and demands substantial attention from key business personnel to explain the production processes. The systems are difficult to use, often requiring the business to have key personnel familiar with certain computer programs or other information technology skills or requires extensive training of key personnel. Finally, present systems are often proprietary and thus expensive, placing them out of the reach for many small businesses.

Therefore, it is readily apparent that there is a need for a system and method for creating, tracking, and analyzing tasks, wherein such a system and method provides users with the ability to track cumulative percentages over all tasks assigned to the user or a subsets of task assigned to the user and track, trend or perform statistical analysis on task completion status and/or task completion percentages. There is further need for such a system and method that enables the assignee of the task to negotiate with the task creator regarding the performance of the task and/or the terms of performing and/or completing the task. There is still further need for such a system and method that obviates the requirement of detailed customization to adapt the system or method to the type of business or product/service, thus reducing the cost to implement and operate such a system or method. There is still a further need for such a system and method that obviates the expense of training personnel in information technology skills to operate the system or method, thus reducing the time requirement required by a user to become skilled in using the system or method.

### BRIEF SUMMARY OF THE INVENTION

Briefly described, in a preferred embodiment, the present invention overcomes the above-mentioned disadvantage, and meets the recognized need for such an invention by providing a system and method for creating, negotiating, tracking, and analyzing tasks, wherein the present invention provides for automated negotiation of tasks between task assignor and task assignee, and wherein the present invention provides for automated tracking and trending of task completion, performing statistical analysis of the task status and task completion, tracking and trending of tasks assigned to an individuals or group of individuals, sets of individuals belonging to a department or organization, tracking and trending groups of tasks making up a project, and tracking and trending of tasks across an entire organization.

According to its major aspects and broadly stated, the present invention in its preferred form is a system and method for creating, tracking, and analyzing task, comprising, in general, a central server system connected to a database storage device, a user station or remote user station connected via the Internet, local area network or wireless communication to the central server for performing task creation, negotiation, tracking, and analyzing. The system is utilized to enable a user to create, describe, assign a task, to create a task due date, start date, status, priority, negotiate the acceptance and/or terms of the task assigned, percentage complete, set reminder dates and times, assign an owner to the task, tracking the status of the task, and performing trending and statistical analysis of tasks.

More specifically, the preferred embodiment of the present invention is a communication system that shares information, and a process wherein the assignee of a task may negotiate the acceptance of a task and/or the terms of performing and/or completing the assigned task; a process for tracking, trending or performing statistical analysis on tasks, task status, and task completion percentages, a process for tracking, trending or performing statistical analysis on cumulative percentages over all tasks assigned to the user or a subsets of task assigned to a user, a process for tracking, trending or performing statistical analysis on task completion status and/or task completion percentages, a process for tracking, trending or performing statistical analysis on tasks assigned to sets of individuals belonging to a department or organization, a process for tracking, trending or performing statistical analysis on groups of tasks making up a project, and a process for tracking, trending or performing statistical analysis on tasks across an entire organization.

Accordingly, a feature and advantage of the present invention is its ability to create, describe, and assign a task, create a task due date, start date, status, priority, percentage complete, set reminder dates and times, and assign an owner to a task.

Accordingly, a feature and advantage of the present invention is its ability to provide a user with the ability to search, view, sort and/or filter a list of tasks.

Another feature and advantage of the present invention is its ability to provide a user with the ability to track multiple tasks, task status, and task completion percentages.

Still another feature and advantage of the present invention is its ability to trend and perform statistical analysis on tasks, task status, and task completion percentages.

Yet another feature and advantage of the present invention is its ability to provide a system and method for negotiating a task or the terms of an assigned task.

Yet another feature and advantage of the present invention is its ability to provide a system and method for providing notice or an alarm regarding the status of a task.

Yet another feature and advantage of the present invention is its ability to provide a system and apparatus for monitoring and reporting task progress.

Yet another feature and advantage of the present invention is its ability to provide a system and apparatus for automated assignment of tasks.

Yet another feature and advantage of the present invention is its ability to provide a system and apparatus for performing trend and statistical analysis on tasks, task status, and task completion percentages.

Yet another feature and advantage of the present invention is its ability to combine tasks management with goal management by tracking and storing tasks and goals in the same location.

Yet another feature and advantage of the present invention is its ability to allow users to input task and goal information and have such information stored and available to other users on the system.

Yet another feature and advantage of the present invention is its ability to simplify the administrative responsibilities of users, employees and managers and thus enable such persons to devote more time to completion of tasks and value added services verses administration of such tasks and management of such users.

In accordance with still another feature and advantage of the present invention, the system helps delegate responsibilities to the user or worker, enhancing worker involvement as well as diminishing worker-management conflict or micro-management, through the use of tasks, priorities, dates of completion and goals.

In accordance with still further aspects of the invention, periodic analysis of task status and completion and target goal achievement can be automatically scheduled for dissemination by the system, such as at the end of each day, week, month or quarter, as a further reminder to the user to maintain focus on company goals.

In accordance with still further aspects of the invention, instruction windows automatically will appear to guide the user along all task creation, set-up and data input, both during initial input and during daily operation.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a block diagram of a computer system of the present invention;

FIG. 2 is a block diagram of a communications system implemented by the computer system in FIG. 1;

FIG. 3 is a flow diagram of a communication method, according to the preferred embodiment of the present invention, implemented via the communications system in FIG. 2;

FIG. 4 is a template exemplar of a user interface of the communication method of FIG. 3 according to the preferred embodiment of the present invention;

FIG. 5 is a screen shot exemplar of a login user interface of the communication method of FIG. 3 according to the preferred embodiment of the present invention;

FIG. 6 is a screen shot exemplar of a detailed login user interface of the communication method of FIG. 3 according to the preferred embodiment of the present invention;

FIG. 7 is a screen shot exemplar of an assigned department's user interface of the communication method of FIG. 3 according to the preferred embodiment of the present invention;

FIG. 8 is a screen shot exemplar of an assigned role's user interface of the communication method of FIG. 3 according to the preferred embodiment of the present invention;

FIG. 9 is a screen shot exemplar of an assigned delegate's user interface of the communication method of FIG. 3 according to the preferred embodiment of the present invention;

FIG. 10 is a screen shot exemplar of a task creation/acceptance user interface of the communication method of FIG. 3 according to the preferred embodiment of the present invention;

FIG. 11 is a screen shot exemplar of a task delegation user interface of the communication method of FIG. 3 according to the preferred embodiment of the present invention;

FIG. 12 is a screen shot exemplar of a task negotiation user interface of the communication method of FIG. 3 according to the preferred embodiment of the present invention;

FIG. 13 is a screen shot exemplar of a task selection user interface of the communication method of FIG. 3 according to the preferred embodiment of the present invention;

FIG. 14 is a screen shot exemplar of a task completion user interface of the communication method of FIG. 3 according to the preferred embodiment of the present invention;

FIG. 15 is a screen shot exemplar of a task statistical analysis user interface of the communication method of FIG. 3 according to the preferred embodiment of the present invention;

FIG. 16 is a screen shot exemplar of a task statistical analysis for a department's user interface of the communication method of FIG. 3 according to the preferred embodiment of the present invention;

FIG. 17 is a screen shot exemplar of a task statistical analysis for an individual's user interface of the communication method of FIG. 3 according to the preferred embodiment of the present invention;

### DETAILED DESCRIPTION OF THE INVENTION

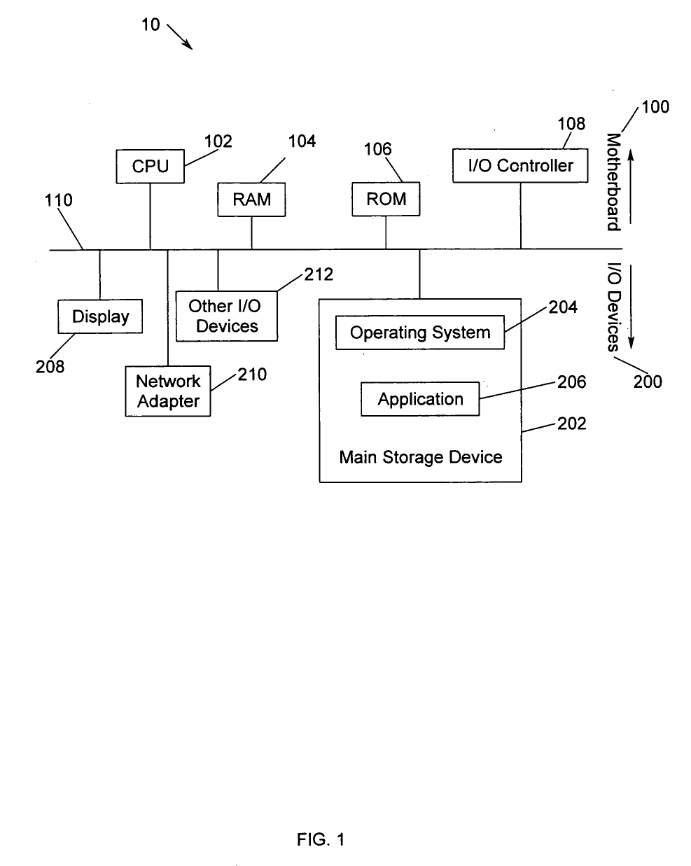

In describing the preferred and alternate embodiments of the present invention, as illustrated in FIGS. 1-17, specific terminology is employed for the sake of clarity. The present invention, however, is not intended to be limited to the specific terminology so selected, and it is to be understood that each specific element includes all technical equivalents that operate in a similar manner to accomplish similar functions.

As will be appreciated by one of skill in the art, the present invention may be embodied as a method, data processing system, or computer program product. Accordingly, the present invention may take the form of an entirely hardware embodiment, entirely software embodiment or an embodiment combining software and hardware aspects. Furthermore, the present invention may take the form of a computer program product on a computer-readable storage medium having computer-readable program code means embodied in the medium. Any suitable computer readable medium may be utilized including hard disks, ROM, RAM, CD-ROMs, electrical, optical or magnetic storage devices.

The present invention is described below with reference to flowchart illustrations of methods, apparatus (systems) and computer program products according to embodiments of the present invention. It will be understood that each block or step of the flowchart illustrations, and combinations of blocks or steps in the flowchart illustrations, can be implemented by computer program instructions. These computer program instructions may be loaded onto a general purpose computer, special purpose computer, or other programmable data processing apparatus to produce a machine, such that the instructions, which execute on the computer or other programmable data processing apparatus create means for implementing the functions specified in the flowchart block or blocks/step or steps.

These computer program instructions may also be stored in a computer-usable memory that can direct a computer or other programmable data processing apparatus to function in a particular manner, such that the instructions stored in the computer-usable memory produce an article of manufacture including instruction means which implement the function specified in the flowchart block or blocks/step or steps. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks/step or steps.

Accordingly, blocks or steps of the flowchart illustrations support combinations of means for performing the specified functions, combinations of steps for performing the specified functions and program instruction means for performing the specified functions. It should also be understood that each block or step of the flowchart illustrations, and combinations of blocks or steps in the flowchart illustrations, can be implemented by special purpose hardware-based computer systems, which perform the specified functions or steps, or combinations of special purpose hardware and computer instructions.

Computer programming for implementing the present invention may be written in various programming languages, such as conventional C calling, database languages such as Oracle or NET. However, it is understood that other source or object oriented programming languages, and other conventional programming language may be utilized without departing from the spirit and intent of the present invention.

Referring now to FIGS. 1-17, the present invention in its preferred embodiment is a method, system and apparatus for creating, tracking, and analyzing tasks, wherein the present invention provides for automated tracking and trending of task completion, performing statistical analysis of the task status and task completion, tracking and trending of tasks assigned to an individuals or group of individuals, sets of individuals belonging to a department or organization, tracking and trending groups of tasks making up a project, and tracking and trending of tasks across an entire organization via the Internet, local area network or wireless.

The system responds to a request from a user to create, describe, assign, create a task due date, start date, status, priority, percentage complete, set reminder dates and times, assign an owner to a task and the negotiation of the task assignment and/or terms of the task completion. Moreover, the system responds to a request from a user to perform tracking, trending and performing statistical analysis on tasks, task status, and task completion percentages. For brevity, several elements in the figures described below are represented as monolithic entities. However, as would be understood by one skilled in the art, these elements each may include numerous connected computers and/or components designed to perform a set of specified operations and/or dedicated to a particular geographical region.

Referring now to FIG. 1, there is illustrated a block diagram of a computer system 10 that provides a suitable environment for implementing embodiments of the present invention. The computer architecture shown in FIG. 1 is divided into two parts—motherboard 100 and the input/output (I/O) devices 200. Motherboard 100 preferably includes subsystems such as central processing unit (CPU) 102, random access memory (RAM) 104, input/output (I/O) controller 108, and read-only memory (ROM) 106, also known as firmware, which are interconnected by bus 110. A basic input output system (BIOS) containing the basic routines that help to transfer information between elements within the subsystems of the computer is preferably stored in ROM 106, or operably disposed in RAM 104. Computer system 10 further preferably includes I/O devices 200, such as main storage device 202 for storing an operating system 204 and application program(s) 206 and display 208 for visual output, respectively. Main storage device 202 preferably is connected to CPU 102 through a main storage controller (represented as 108) connected to bus 110. Network adapter 210 allows the computer system to send and receive data through communication devices. One example of a communications device is a modem including both cable and digital subscriber line (DSL). Other examples include a transceiver, a set-top box, a communication card, a satellite dish, an antenna, or any other network adapter capable of transmitting and receiving data over a communications link that is either a wired, optical, or wireless data pathway.

Many other devices or subsystems 212 may be connected in a similar manner, including but not limited to, devices such as microphone, speakers, sound card, keyboard, pointing device (e.g., a mouse), floppy disk, CD-ROM player, DVD player, printer and/or modem each connected via an I/O adapter. Also, although preferred, it is not necessary for all of the devices shown in FIG. 1 to be present to practice the present invention, as discussed below. Furthermore, the devices and subsystems may be interconnected in different configurations from that shown in FIG. 1, or may be based on optical or biological processors or gate arrays, or some combination of these elements that is capable of responding to and executing instructions. The operation of a computer system such as that shown in FIG. 1 is readily known in the art and is not discussed in further detail in this application, so as not to overcomplicate the present discussion.

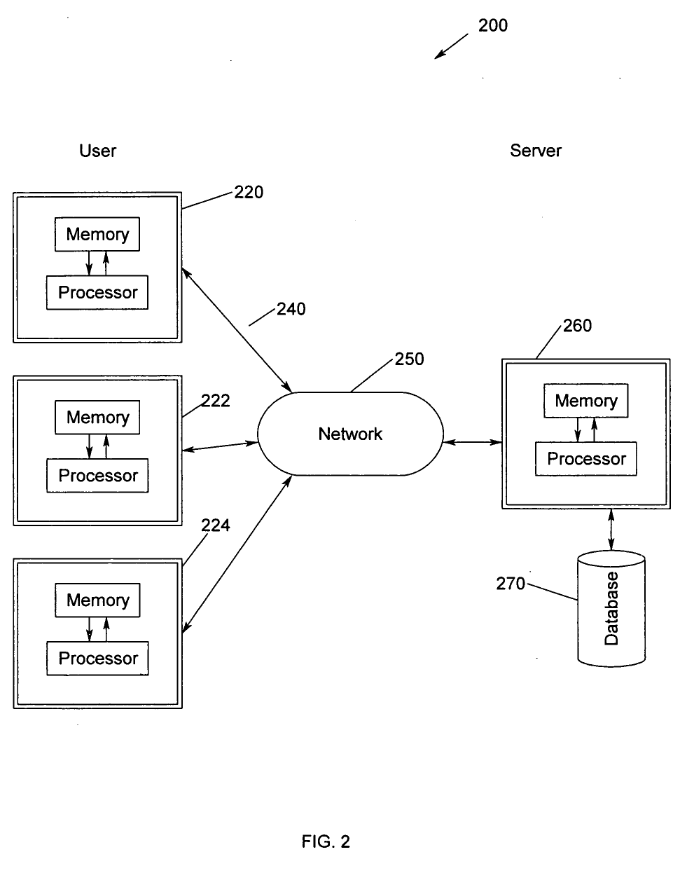

Referring now to FIG. 2, there is illustrated a diagram depicting an exemplary system in which concepts consistent with the present invention may be implemented. Examples of each element within the communication system of FIG. 2 are broadly described above with respect to FIG. 1. In particular, the server system 260 and user system 220 have attributes similar to computer system 10 of FIG. 1 and illustrate one possible implementation of computer system 10. Communication system 200 preferably includes one or more user systems 220, one or more server devices 260, and network 250, which could be, for example, the Internet. User systems 220 each preferably include a computer-readable medium, such as random access memory, coupled to a processor. The processor executes program instructions stored in memory. User system 220 may also include a number of additional external or internal devices, such as, without limitation, a mouse, a CD-ROM, a keyboard, a display, a storage device and other attributes similar to computer system 10 of FIG. 1. The communications system 200 typically includes one or more user system 220. For example, user system 220 may include one or more general-purpose computers (e.g., personal computers), one or more special purpose computers (e.g., devices specifically programmed to communicate with each other and/or the server system 260), a workstation, a server, a device, a digital assistant or a “smart” cellular telephone or pager, a component, other equipment, or some combination of these elements that is capable of responding to and executing instructions.

Similar to user system 220, server system 260 preferably includes a computer-readable medium, such as random access memory, coupled to a processor. The processor executes program instructions stored in memory. Server system 260 may also include a number of additional external or internal devices, such as, without limitation, a mouse, a CD-ROM, a keyboard, a display, a storage device and other attributes similar to computer system 10 of FIG. 1. Server system 260 may additionally include a secondary storage element, such as database 270 for storage of data and information. Server system 260, although depicted as a single computer system, may be implemented as a network of computer processors. Memory in server system 260 contains one or more application program(s) 206 (shown in FIG. 1) For example, the server system 260 may include one or more general-purpose computers (e.g., personal computers), one or more special purpose computers (e.g., devices specifically programmed to communicate with each other) a workstation or other equipment, or some combination of these elements that is capable of responding to and executing instructions.

Communications system 200 is capable of delivering and exchanging data between user system 220 and a server system 260 through communication links 240 and/or network 250. Through user system 220, users can preferably communicate over network 250 with each other and with other systems and devices coupled to network 250, such as server system 260. Communications link 240 typically includes a delivery network 250 making a direct or indirect communication between the user system 220 and the server system 260, irrespective of physical separation. Examples of a network 250 include the Internet, the World Wide Web, WANs, LANs, analog or digital wired and wireless telephone networks (e.g. PSTN, ISDN, or XDSL), radio, wireless, television, cable, satellite, and/or any other delivery mechanism for carrying and/or transmitting data or other information. The communications link 240 may include, for example, a wired, wireless, cable, optical or satellite communication system or pathway.

Application program 206 (shown in FIG. 1) preferably includes a task manager, which enables a user to create, describe, and assign a task, to create a task due date and start date, set status, priority, and percentage complete, set reminder dates and times, assign an owner to a task in response to requests from user system 220; a trend manager, which enables tracking and trending of task completion, performing statistical analysis of the task status and task completion, tracking and trending of tasks assigned to an individuals or group of individuals, sets of individuals belonging to a department or organization, tracking and trending groups of tasks making up a project, tracking and trending of tasks across an entire organization, setting notices or alarms upon task surpassing scheduled completion dates and enabling the notification of users, the assignor of the task or other designated users based on task status and/or completion; a search engine, which locates relevant information in response to search queries from user system 220; and a statistical analyzer, which enables historical data gathering tracking and trending of tasks as well as managing task flow, and assignment of tasks; project, process and resource bottleneck analysis, flow optimization and automatic workload balancing and enabling dynamic statistical information such as availability and work load. In particular, a user operating user system 220 preferably creates a task, negotiates a task, send data or information, and send queries or information requests to server system 260, wherein server system 260 and its application programs respond by creating the task and/or returning the sought information to the user at user system 220. Preferably, user system 220 communicates with server system 260 to create a task, negotiate a task or to locate information relating to one or more tasks assigned to individuals or users of user system 220. Communications system 200 preferably enables users to communicate tasks via user system 220 and server system 260, and share information related to such tasks. Further, communications system 200 preferably provides users of user system 220 a registration template with fill-in the blank and user selected criteria for identifying the user and linking the user to tasks assigned to such user.

In general, processes for indexing records and searching an indexed body of records to return a set of records containing the search or query terms or information request are well known in the art, wherein any suitable indexing, tracking, trending, analysis process maybe utilized in support of the functionality of the present invention and relative to task management.

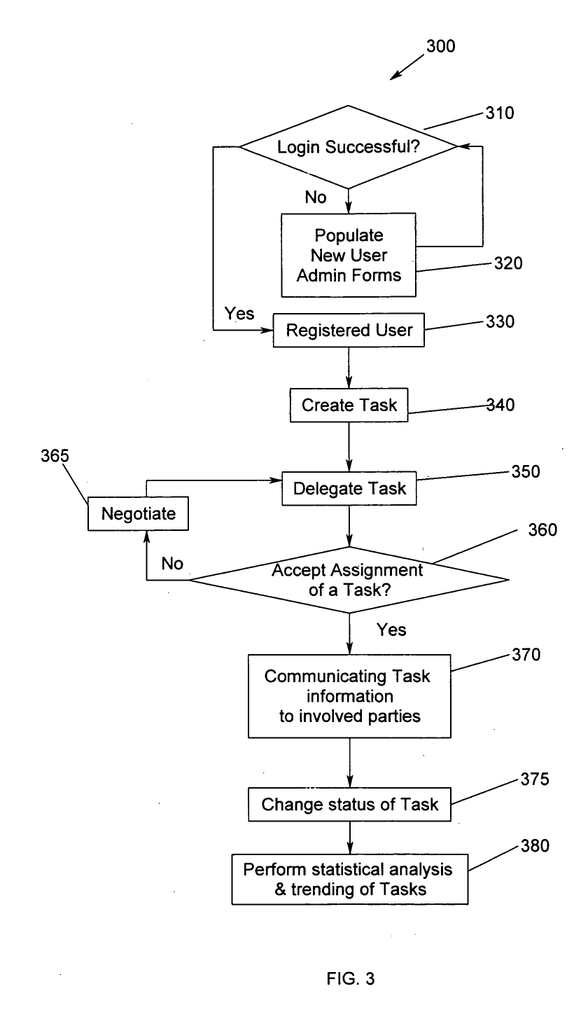

Referring now to FIG. 3, there is illustrated a preferred flow diagram in which user 220, user 222 and server system 260 of communication system 200 of FIG. 2 interact according to communication method 300 within the communication system 200 of FIG. 2. Communication method 300 preferably can be implemented by communication system 200 or other similar hardware, software, device, computer, computer system, equipment, component, application, code, storage medium, or propagated signal.

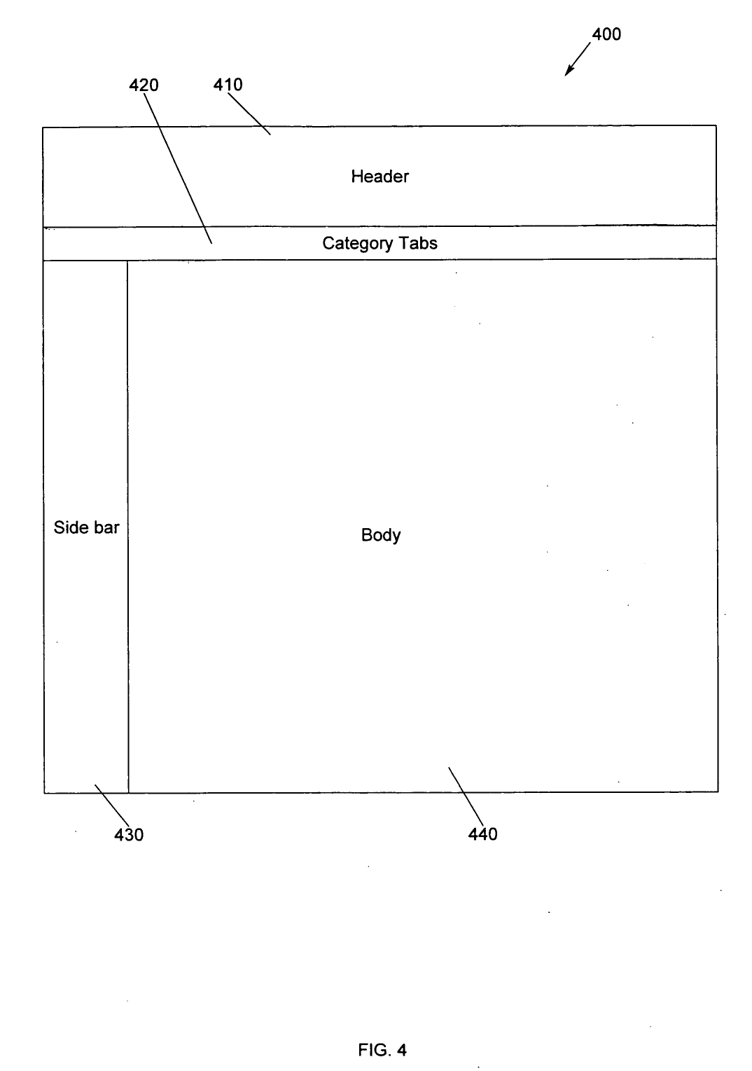

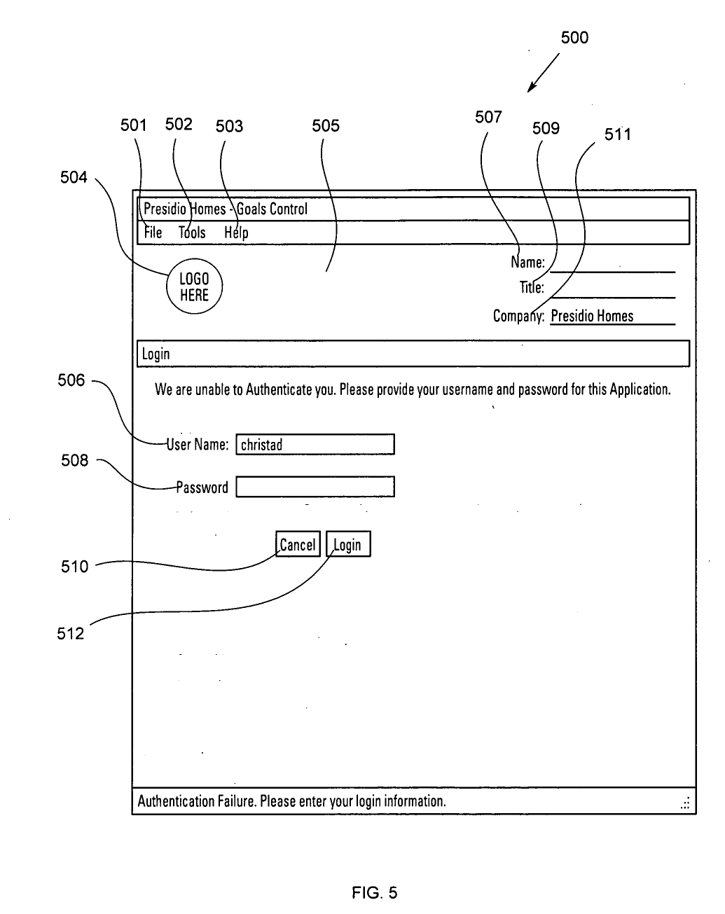

As illustrated in FIG. 3, preferred communication method 300 starts with step 310, wherein users 220/222 preferably sends to server system 260 a request to login via network 250. In response, server system 260 preferably sends user 220/222 at least one template 400 (see FIG. 4) further defined in FIGS. 5-9 for user 220/222 to use to guide user 302 through further steps set forth in FIG. 3.

Referring to FIG. 4, template 400 preferably is a general user interface (GUI) computer screen such as a website page(s) and the like having text, graphics, text entry windows, drop down selection windows, radial selection buttons, clickable buttons and the like. Moreover, user 220/222 preferably can personalize or customize template 400 designated as user 220/222 landing page with text, graphics, pictures, audio files, video files and the like. GUIs and website pages are readily known in the art and are not discussed in further detail in this application, so as not to overcomplicate the present discussion. Moreover, website and GUI pages are stored in database 270 and are delivered to user 220/222 via server system 260 and network 250. Template 400 preferably includes but is not limited to header 410, category tabs 420, side bar 430, and body 440 which organize the page into regions having text, graphics, text entry windows, tabs, hyper links, drop-down selection windows, radial buttons, clickable buttons and the like. Any suitable format may be utilized for expression of the information.

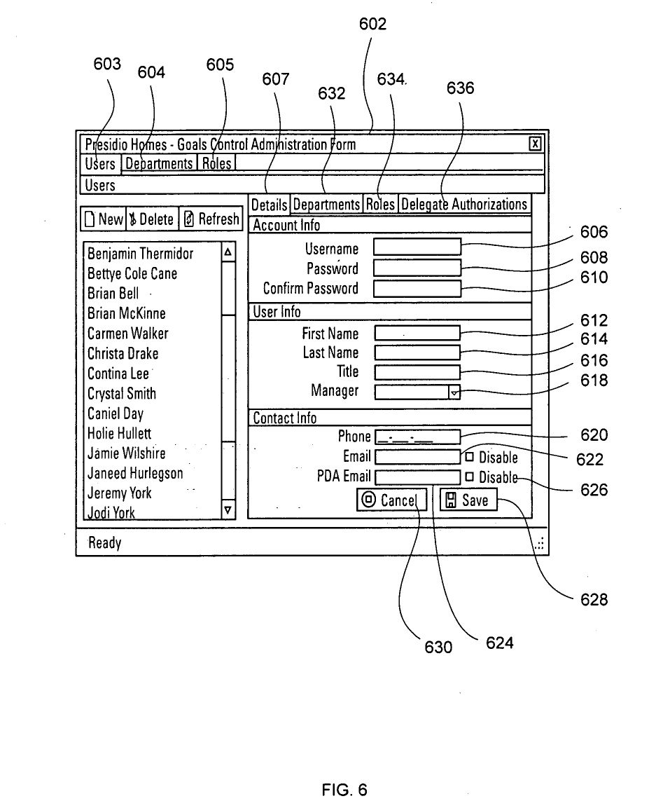

Referring back to FIG. 3 and step 310 of process 300, users 220/222 preferably enters a user name and password in screen shot 500 to log into server system 260 and gain access to application program 206. Upon server system 260 receiving users 220/222 name and password server system 260 checks such information against users 220/222 login record stored in database 270. If server system 260 finds a match between users 220/222 submitted name and password and users 220/222 records, users 220/222 is granted access to application program 206. However, if user 220/222 is not registered with server system 260 user 220/222 preferably must enroll, to become a member/user and/or to create a member/user profile with server system 260 (step 320). Server system 260 preferably receives the instruction that user 220/222 requests to become a member/user and/or to create a member/user profile. In response, server system 260 preferably sends user 220/222 at least one template 400 (see FIG. 4) further defined in FIG. 6 for user 220/222 to use to guide user 220/222 through further steps set forth in FIG. 3. In step 320, user 220/222 preferably selects a unique user name and password, and user 220/222 may provide additional information as a user profile such as name, title, company number, address, mail stop, telephone number, email address, department, names of direct reports, supervisor's name and the like (“user information 12”) to be stored by server system 260 as a record for user 220/222. Further, in step 320, user 220/222 preferably may select user groups assigned to user 220/222 such as direct reports departments managed, supervisors or colleagues, wherein user 220/222 preferably is enabled to create and assign tasks to such users as well as receive and accept tasks assigned by such users in user 220/222 user group. Still further, in step 320, user 220/222 preferably selects one or more users to be an assigned delegate of user 220/222, wherein user 220/222 preferably is enabled to delegate tasks to such users.

Referring to FIG. 5, there is illustrated a preferred screen shot 500 of a user interface disclosing a template to enter user login details, including drop down tabs for file 501, tools 502, help 503 or other such user information as would meet the purposes described herein. Operator of screen shot 500 preferably places a company logo, trademark, tag line or other indicia 504 in banner area 505. Moreover, operator of screen shot 500 preferably displays company name 511 in banner area 505. User 220/222 preferably enters an alphanumeric entry into user name 506 and password 508 and clicks login button 512 to gain access to server system 260. If server system 260 determines a match exists between user name 506 and password 508 submitted by user 220/222 and user 220/222 records stored in database 270 user 220/222 is granted access to server system 260 and application program 206. If no match, user 220/222 is denied access to server system 260. User 220/222 may elect to cancel the login step 310 preferably by user 220/222 clicking cancel button 510 to cancel step 310.

Referring to FIG. 6, there is illustrated a preferred screen shot 600 of a user interface template to create a user login account, including pop up entry window 602, tabs for user 603, departments 604, roles 605 or other such user information as would meet the purposes described herein. User 220/222 (or an administrator of server system 260) preferably clicks details tab 607 and server system 260 receives this command and preferably sends user 220/222 screen shot 600, wherein user 220/222 (or an administrator of server system 260) enters alphanumeric account information into text boxes for username 606, password 608, and confirm password 610; user information entry into text boxes for first name 612, last name 614, title 616, and manager 618; and contact information into text boxes for phone number 620, email address 622, and personal digital assistant (PDA) 624 and the like. An email entry can be placed in one or both accounts, email address 622, and/or personal digital assistant (PDA) 624 activating the delivery of information by server system 260 to such accounts. Either account, whether email address 622, and/or personal digital assistant (PDA) 624, is deactivated (disabling delivery of information by server system 260 to such accounts) preferably by user 220/222 clicking disable box 626 associated with such account. Upon user 220/222 entering the above information or editing such information user 220/222 clicks save 628 to send user information 12 to server system 260 and database 270, wherein server system 260 creates an account for user 220/222 (Registered User) and server system 260 stores user information 12 in database 270. Alternatively, user 220/222 may click cancel 630 to cancel entering information 12 in step 320 of process 300.

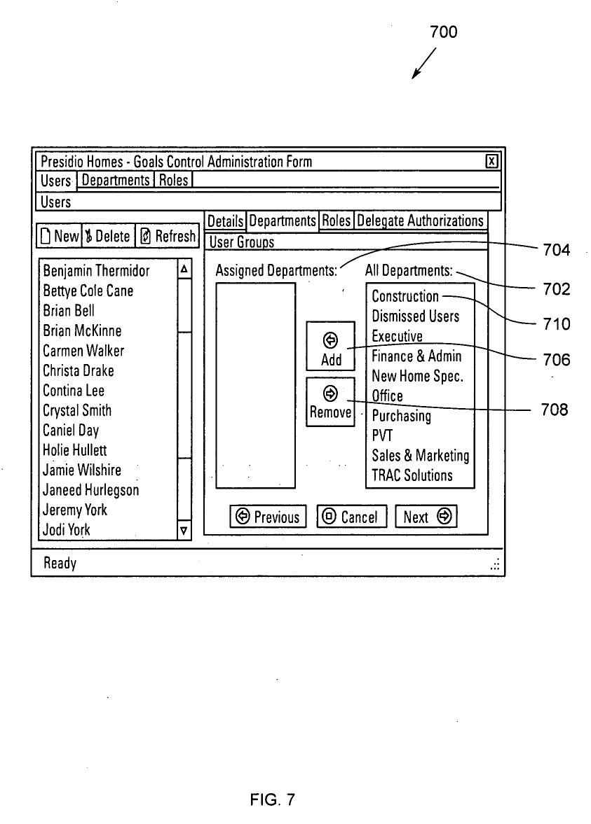

Referring to FIG. 7, there is illustrated a preferred screen shot 700 of a user interface template, wherein user 220/222 (or an administrator of server system 260) preferably selects user groups for user 220/222 to be join, link to and/or associated with. User group includes but is not limited to, department, role, position of hierarchy, delegates, reports, mananger(s) and the like. User 220/222 preferably clicks departments tab 604 or 632 and server system 260 receives this command and preferably sends user 220/222 screen shot 700, wherein user 220/222 (or an administrator of server system 260) preferably selects a department from the list of departments 710 under all departments 702 and preferably clicks add 706, wherein server system 260 receives this command and places the selected department in assigned departments 704 for user 220/222. Preferably, the list of departments 710 for this company includes, but is not limited to construction, dismissed users, executive, finance & administration, new home specialists, office, purchasing, PVT, sales & marketing, and TRAC Solutions, as well as legal, business development, IT, engineering, and the like or any other group of users as would meet the purposes described herein. Alternatively to remove a department, user 220/222 preferably selects a department from the list of assigned departments under assigned departments 704 and clicks remove 708, wherein server system 260 receives this command and returns the selected department to all departments 702 for user 220/222. User 220/222 may select, add, or remove departments.

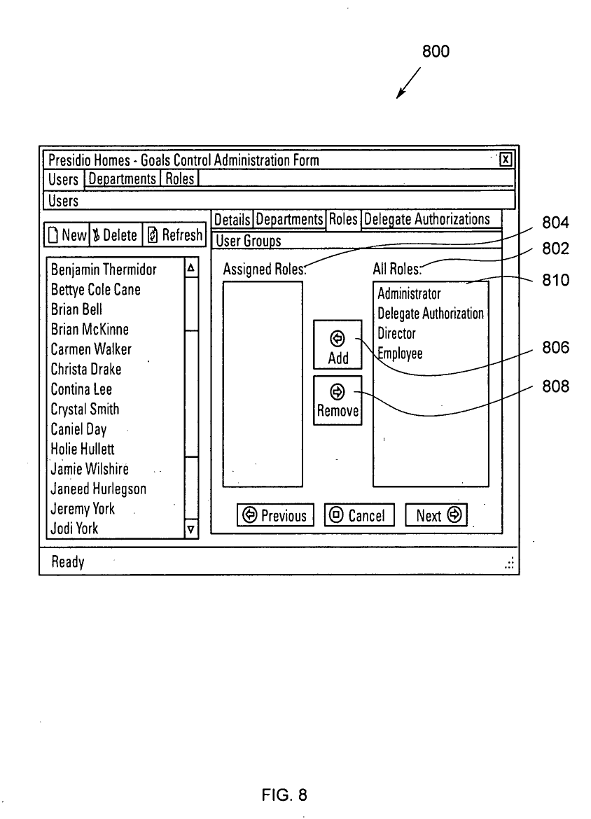

Referring to FIG. 8, there is illustrated a preferred screen shot 800 of a user interface template, wherein user 220/222 selects a position in a hierarchy. User 220/222 (or an administrator of server system 260) preferably clicks roles tab 605 or 634 and server system 260 receives this command and preferably sends user 220/222 screen shot 800, wherein user 220/222 (or an administrator of server system 260) preferably selects a role from the list of roles 810 under all roles 802 and clicks add 806, wherein server system 260 receives this command and preferably places the selected role in assigned roles 804 for user 220/222. Preferably, list of roles 810 for this company includes, but is not limited to administrator, delegate authorization, director, employee, as well as manager, or other employment or task classification, or any other designation as would meet the purposes described herein. Alternatively to remove a role, user 220/222 preferably selects a role from the list of assigned roles under assigned roles 804 and clicks remove 808, wherein server system 260 receives this command and returns the selected role to all roles 802.

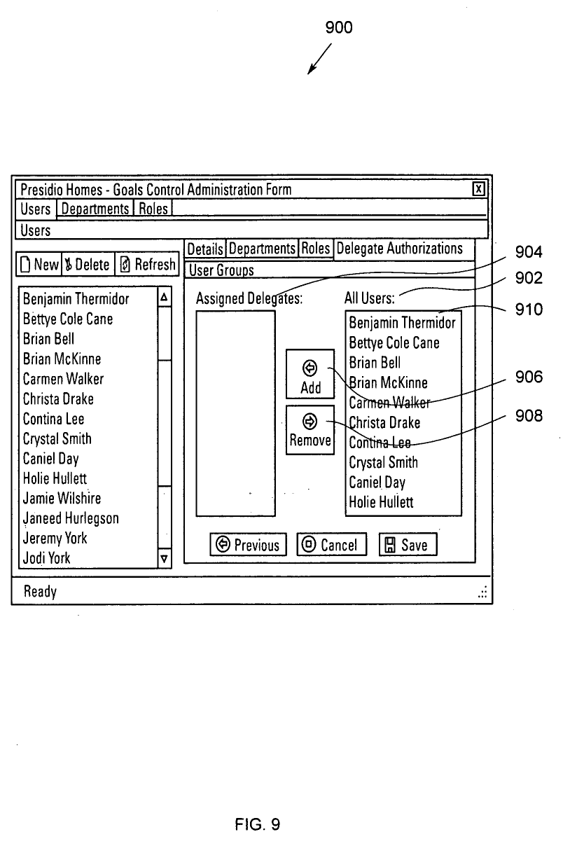

Referring to FIG. 9, there is illustrated a preferred screen shot 900 of a user interface template, wherein user 220/222 selects users to whom user 220/222 may assign tasks. User 220/222 (or an administrator of server system 260) preferably clicks delegate authorization tab 636 and server system 260 receives this command and preferably sends user 220/222 screen shot 900, wherein user 220/222 (or an administrator of server system 260) preferably selects a user from the list of users 910 under all users 902 and clicks add 906, wherein server system 260 receives this command and places the selected user in assigned delegates 904 for user 220/222. Preferably, list of users 910 for this entity includes, but is not limited to all registered users or a subset of such users or any other delegates as would meet the purposes described herein. Alternatively to remove a delegate, user 220/222 preferably selects a user from the list of users under assigned delegates 904 and clicks remove 908, wherein server system 260 receives this command and returns the selected user to all users 902.

Next according to FIG. 3, in step 330 of communication method 300, user 220/222 preferably is a registered user of server system 260 having the attributes defined in FIGS. 5-9.

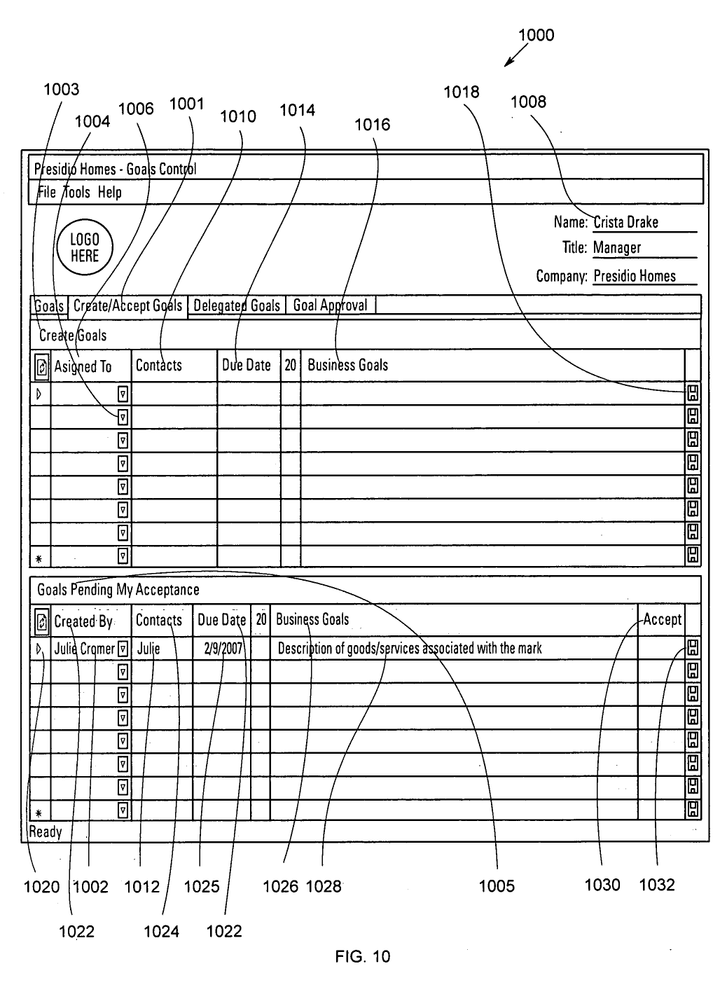

Next according to FIG. 3, in step 340 of communication method 300, wherein users 220/222 preferably sends to server system 260 a request to log a new task via network 250. In response, server system 260 preferably sends user 220/222 at least one template 400 (see FIG. 4) further defined in FIG. 10 for user 220/222 to use to guide user 220 through further steps set forth in FIG. 3. Specifically, in step 340 of process 300, user 220 preferably creates a task utilizing at least one template 400 and assigns such task a profile including but not limited to assigning such task to user 222, setting a due date for the completion of the task, providing a description of the task to be completed and sending such request to server system 260. In response, server system 260 preferably sends user 222 and/or user 220 at least one template 400 representing that a pending task has been assigned to user 222 by user 220, including a description of the task, task due date for the completion and a description of the task to be completed and the like.

Referring to FIG. 10, there is illustrated a preferred screen shot 1000 of a user interface disclosing a template, wherein user 220/222 preferably may create and delegate a task by clicking on tab 1001 entitled “Create/Accept Goals”, which is further defined by section 1003 entitled “Create Goals”, which includes drop down selection windows, date entry window, calendar selection graphic, and description text windows or other such user selection capabilities for creating a task as would meet the purposes described herein. User 220, (shown as “Julie Cromer” 1002) on screen shot 1000, preferably logs into server system 260 and begins creating a task by clicking on drop-down selection window 1004 under column 1006 entitled “Assigned To” and selects user 222 (shown as “Christa Drake” 1008) from the list of possible users to assign and delegate a task. It should be understood that user 220 may be limited to assigning tasks to users such as users 222 based on the permissions set by or for user 220 in FIGS. 7-9. Server system 260 preferably populates column 1010 entitled “Contacts” with user 220 (shown as “Christa” 1008) shown in FIG. 1000 the user being assigned the task. Next, user 220 preferably selects a date of completion for the task by entering a month, day, and year in column 1014 entitled “Due Date” or by clicking a specific day in a graphical calendar representation of a selected month in a selected year. It is contemplated herein that Due Date 1014/1022 preferably is prioritized by an additional column, icon or color such as preferably green, yellow and red to indicate the firmness of such Due Date (priority due date). For example, red represents the task must be completed on such date, yellow represents there exists some flexibility in the Due Date and green represents that the Due Date is a proposed Due Date for the completion of the task. Next, user 220 preferably describes the task to be completed by user 222 under column 1016 entitled “Business Goals” by entering a description of the task to be performed by user 222. Upon populating the required fields in screen shot 1000 for creating a task user 220 clicks the save icon 1018 to save the task, thus, sending the new task created by user 220 to server system 260.

In response, server system 260 preferably sends user 222 revised screen shot 1000 further defined by section 1005 entitled “Goals Pending My Acceptance”, populated with task creation/profile information such as who created the task, the date the task is to be completed and a description of the task or other such task creation information as would meet the purposes described herein. Moreover, server system 260 preferably sends user 222, (shown as “Christa Drake” 1008) on screen shot 1000, task creation information, wherein screen shot 1000 preferably is populated with task creation information created by user 220 to be reviewed by user 222. Specifically, section 1005 includes tasks assigned to user 222 and more specifically with task creation information for task 1020, including, but not limited to column 1022 entitled “Created By”, wherein user 220 (shown as “Julie Cromer” 1002) is identified as the user who created task 1020 to be completed by user 222 (shown as “Christa Drake” 1008); column 1024 entitled “Contacts”, wherein user 220 (shown as “Julie” 1012) is identified as the user to contact regarding task 1020; column 1026 entitled “Due Date”, wherein user 220 selected the due date for task 1020 (shown as “02/19/2007” 1025); and column 1024 entitled “Business Goals”, wherein user 220 described task 1020 (shown as “Description of goods/services with the mark” 1028). Upon user 222 reviewing task 1020 user 222 preferably may elect to accept to perform task 1020 by clicking the save icon 1018 in column 1030 entitled “Accept” to accept the task, thus, preferably sending server system 260 an acknowledgement that task 1020 created by user 220 has been accepted by user 222. Server system 260 preferably populates column 1030 with user 222 name 1008, initials or other designation indicating that user 222 has accepted task 1020 created by user 220.

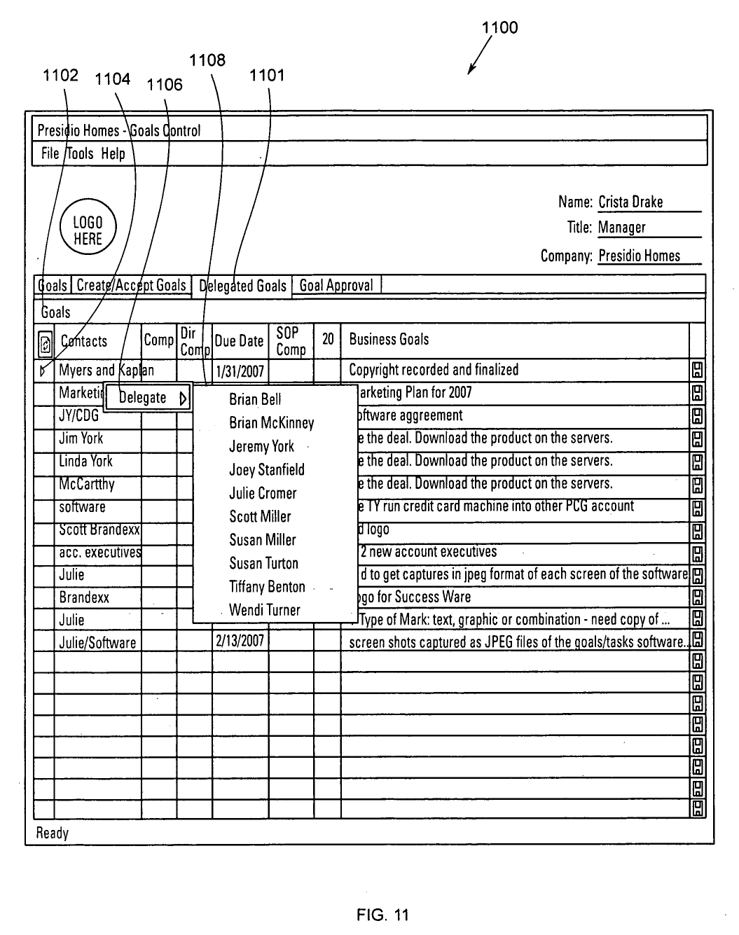

Next, according to FIG. 3, in step 350 of communication method 300, user 222 delegates for example task 1020 to user 224 preferably by sending to server system 260 a request to delegate or re-delegate task 1020 via network 250. In response, server system 260 preferably sends user 222 at least one template 400 (see FIG. 4) further defined in FIG. 11 for user 222 to use to guide user 222 through further steps set forth in FIG. 3. Specifically, in step 350 of process 300, user 222 preferably delegates task 1020 to a new user 224.

Referring to FIG. 11, there is illustrated a preferred screen shot 1100 of a user interface disclosing a template 400, wherein user 222 preferably delegates or re-delegates a task by clicking on tab 1101 entitled “Delegated Goals”, which is further defined by section 1102 entitled “Goals”, which includes task selection and drop down selection windows or other such user selection capabilities for delegating a task as would meet the purposes described herein. User 222 preferably selects a task to delegate by clicking on an individual task from a list of tasks, such as task 1104. In response, server system 260 preferably sends user 222 preferred drop-down selection window 1106, wherein user 222 preferably clicks on a new user from a list of new users 1108 to delegate the performance and/or completion of task 1104. Upon user 222 clicking on a new user to delegate or re-delegate task 1104, server system 260 updates FIG. 10, section 1005 entitled “Goals Pending My Acceptance” for new user 224 as a new task awaiting new user's 224 review and/or acceptance.

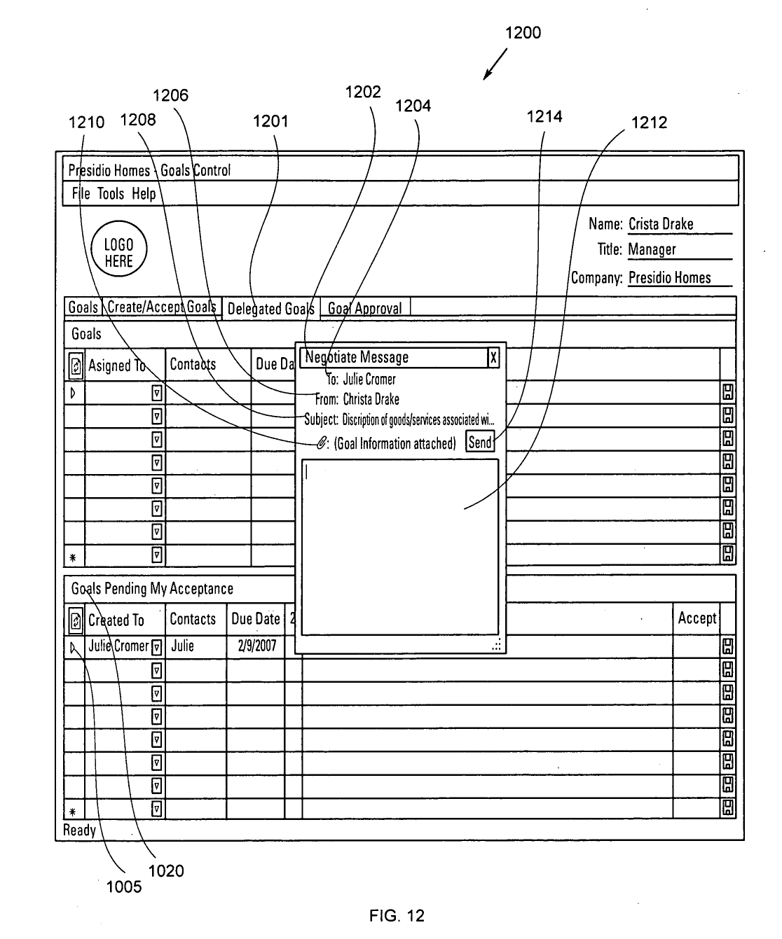

Next, according to FIG. 3, in step 365 of communication method 300, user 222 preferably may elect to negotiate the assignment of a task or the terms of the task preferably by sending to server system 260 a request to negotiate or re-negotiate a task such as task 1104 (as shown in FIG. 11) or task 1020 (as shown in FIG. 10) via network 250. In response, server system 260 preferably sends user 222 at least one template 400 (see FIG. 4) further defined in FIG. 12 for user 222 to use to guide user 222 through further steps set forth in FIG. 3. Specifically, in step 365 of process 300, user 222 preferably elects to negotiate or re-negotiate a task by right clicking task 1104 or task 1020.

Referring to FIG. 12, there is illustrated a preferred screen shot 1200 of a user interface disclosing a template 400, wherein user 222 (shown as “Christa Drake” 1008) preferably elects to negotiate or re-negotiate a task by clicking on tab 1201 entitled “Delegated Goals” and by clicking (or right clicking) on an individual task from a list of tasks, such as task 1020 under section 1005. In response, server system 260 preferably sends user 222 preferred negotiation message board 1202 (template), wherein user 222 preferably elects to send a message to user 220 requesting to negotiate or re-negotiate of task 1020 or the terms of a task 1020 including, but not limited to due date and description. Server system 260 preferably populates negotiation message board 1202 with to field 1204, creator of task 1020 entitled “To: Julie Cromer”; from field 1206 with the current delegated party of task 1020 user 222 entitled “From: Christa Drake”; subject field 1208 with the business goal/ description of the task entitled “Description of goods/services with the mark”; attachment 1210, wherein user 222 preferably attaches supporting documentation to negotiation message 1202; and message 1212, wherein user 222 communicates to user 220 the rationale for negotiating or re-negotiating task 1020. Upon user 222 clicking send button 1214, server system 260 sends user 222 negotiation message 1202 to user 220. It is contemplated herein that user 220 may reply to user 222 negotiation message 1202 and negotiate or re-negotiate task 1020 still further with user 222. It is still further contemplated that negotiation message 1202 preferably is based on email messaging and an email application program 206 residing on server system 260 or alternatively negotiation message 1202 may be communicated between users 220/222 and server system 260 via instant messaging or any other form of communication as would meet the purposes described herein.

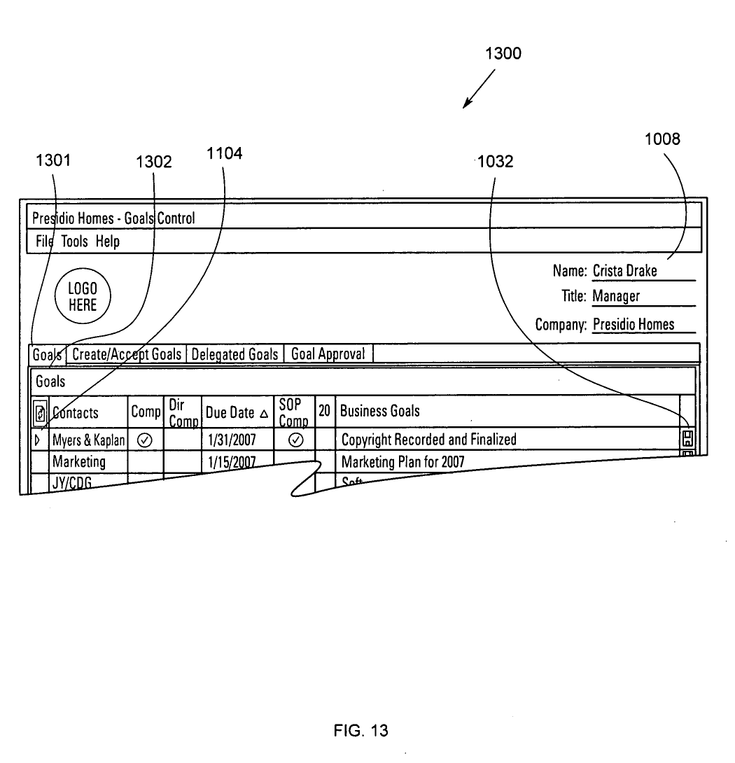

Next, according to FIG. 3, in step 360 of communication method 300, user 222 preferably elects to accept the assignment of a task and the terms of the task preferably by sending to server system 260 a request to accept the task, such as task 1104 or 1020, via network 250. In response, server system 260 preferably sends user 222 at least one template 400 (see FIG. 4) further defined in FIG. 13 for user 222 to use to guide user 222 through further steps set forth in FIG. 3. Specifically, in step 360 of process 300, user 222 preferably elects to accept task 1104 or 1020 by clicking task 1104 or 1020, thus selecting the task.

Referring to FIG. 13, there is illustrated a preferred screen shot 1300 of a user interface disclosing a template 400, wherein user 222 preferably elects to accept a task by clicking on tab 1301 entitled “Goals”, which is further defined by section 1302 entitled “Goals” (a list of all task assigned to user 222 (shown as “Christa Drake 1008”)). Preferably, user 222 clicks on an individual task from a list of tasks, such as task 1104 to accept task 1104. Upon user 220 and user 222 agreeing on the task to be performed and its terms user 222 preferably accepts task 1104 by clicking the save icon 1032 to accept task 1104 (step 360), thus, sending server system 260 an acknowledgement that task 1020 created by user 220 has been accepted by user 222. Server system 260 preferably populates column 1030 shown in FIG. 10 with user 222 name “Christa Drake 1008”, initials, icon, graphic or other designation indicating that user 222 has accepted task 1104 created by user 220.

Next, according to FIG. 3, in step 370 of communication method 300, server system 260 communicates, to user 220, user 222, users 220/222 supervisors, managers, department heads, executives or any other linked user of server system 260, any updates, status changes and/or other task information as would meet the purposes described herein.

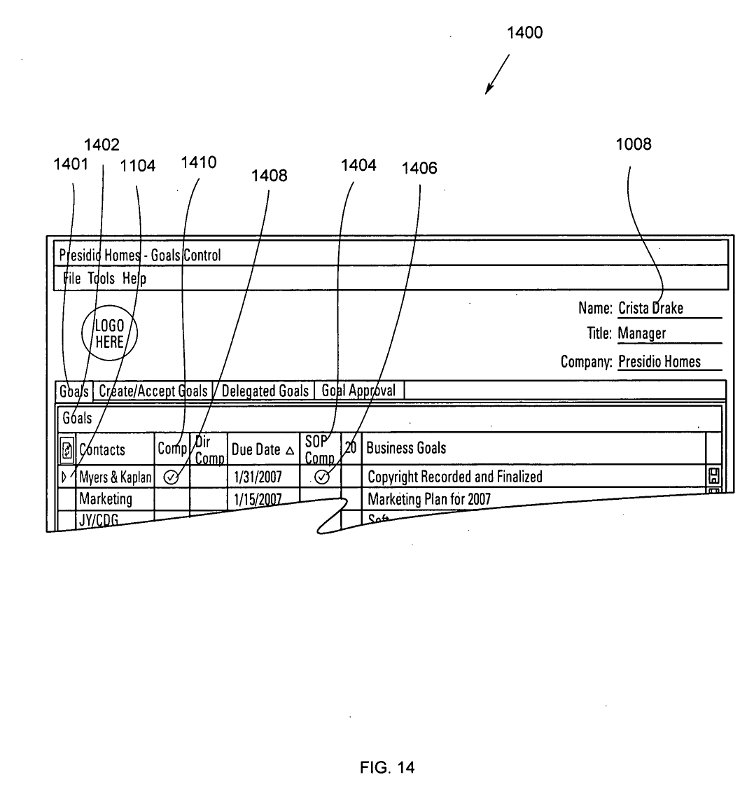

Next, according to FIG. 3, in step 375 of communication method 300, user 222 preferably elects to change the status of a task from pending to start or complete. For example, user 222 preferably elects to change the status of task 1104 by sending to server system 260 a request to change the status of a task 1104 assigned to user 222 via network 250. In response, server system 260 preferably sends user 222 at least one template 400 (see FIG. 4) further defined in FIG. 14 for user 222 to use to guide user 222 through further steps set forth in FIG. 3. Specifically, in step 375 of process 300, user 222 preferably elects to change the status of a task 1104.

Referring to FIG. 14, there is illustrated a preferred screen shot 1400 of a user interface disclosing a template 400, wherein user 222 preferably elects to change the status of a task from pending, start, active, work-in-progress, to completed or other such designated status as would meet the purposes defined herein by clicking on tab 1401 entitled “Goals”, which is further defined by section 1402 entitled “Goals” (a list of all task assigned to user 222 (shown as “Christa Drake 1008”)), and preferably by clicking on an individual task from a list of tasks, such as task 1104 user 220 selects a task to change its status. User 222 preferably elects to change the status of task 1104 from pending or active to start by clicking cell 1406 in column 1404 entitled “SOP Comp” defined as start of production (SOP) and in-line with task 1104. In response, server system 260 preferably sends user 222 an updated screen shot 1400 with a check mark in cell 1406. It is contemplated herein that other status other than start for task 1104 are contemplated herein including, but not limited to active status. Moreover, user 222 preferably elects to change the status of task 1104 from pending to complete by clicking cell 1408 in column 1410 entitled “Comp” defined as complete (task complete) and in-line with task 1104. In response, server system 260 preferably sends user 222 an updated screen shot 1400 with a check mark in cell 1408. It is contemplated herein that alternate embodiments for expressing a change in status are contemplated herein, including, but not limited to a percentage complete, wherein user 222 alternately clicks on cell 1406 or 1408 and enters a percentage or selects from a drop-down window having increments of percentages to select from.

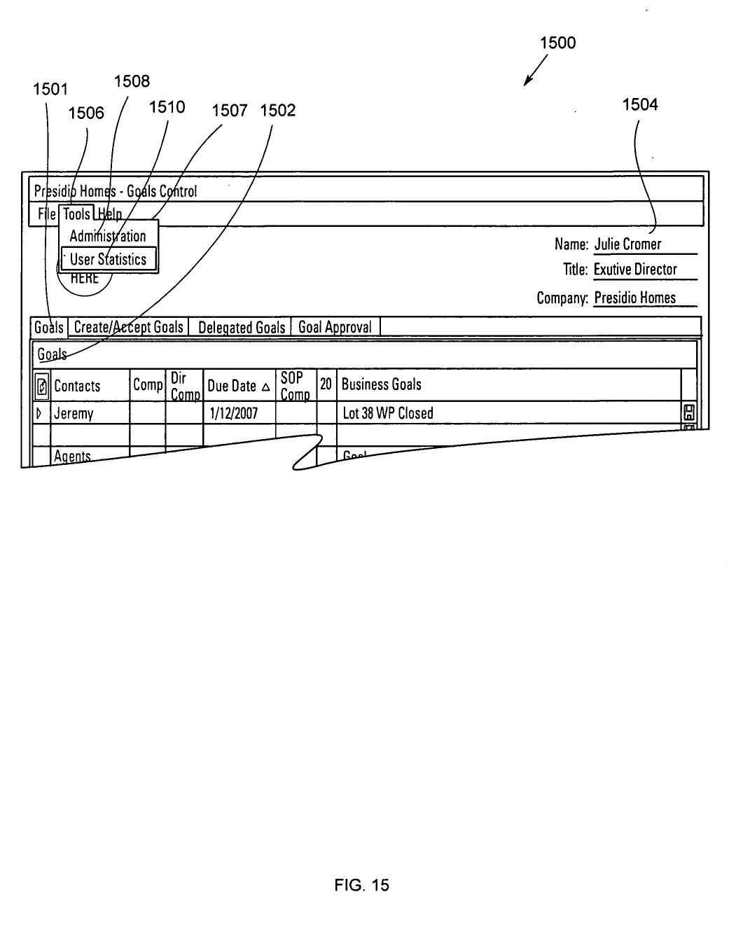

Next, according to FIG. 3, in step 380 of communication method 300, user 220/222 elects to view information and/or generate reports on tracking and trending of task status, completion, performance, performing statistical analysis of task status and task completion, tracking and trending of tasks assigned to an individuals or group of individuals, sets of individuals belonging to a department or organization, tracking and trending groups of tasks making up a project, and tracking and trending of tasks across an entire organization (analysis or reporting). In response to such search query, server system 260 preferably sends user 220/222 at least one template 400 (see FIG. 4) further defined in FIGS. 15-18 for user 220/222 to use to guide user 220/222 through further steps set forth in FIG. 3.

Referring to FIG. 15, there is illustrated a preferred screen shot 1500 of a user interface disclosing a template 400, wherein user 220 preferably elects to run user statistics/analysis under tab 1501 entitled “Goals”, which is further defined by section 1502 entitled “Goals” (a list of all task assigned to user 220 (shown as “Julie Cromer 1504”)), and by preferably clicking on tools 1506 a drop-down window 1507 appears having user options of administration 1508 and user statistics 1510. Upon user 220 clicking on user statistics 1510 user 220 preferably elects to view information and/or generate reports on tracking and trending of task status and/or completion.

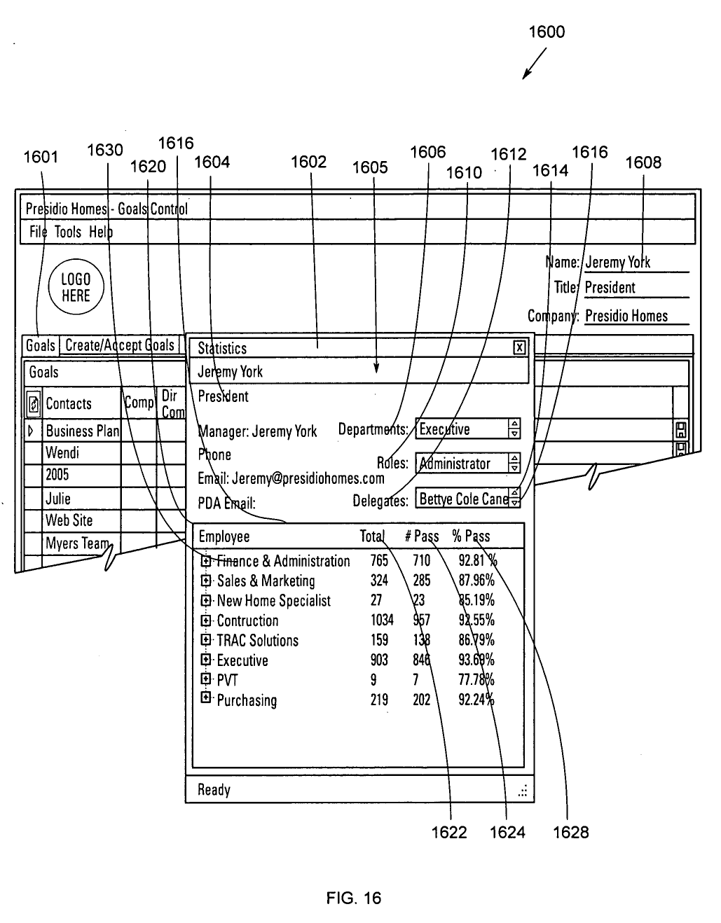

Referring to FIG. 16, there is illustrated a preferred screen shot 1600 of a user interface disclosing a template 400, wherein user 224 preferably elects to run user statistics/analysis under tab 1601 entitled “Goals.” In response to user 224 (shown as “Jeremy York” 1608) selection in FIG. 15, server system 260 preferably sends user 224 an updated screen shot 1600 preferably with window 1602 entitled “Statistics” for performing statistical analysis of the task status and task completion for departments and the like. Window 1602 preferably includes user 224 user information 1604 (same as user information 12 above). Moreover, window 1602 preferably includes query application 1605, which further includes text window 1606 entitled “Departments”, text window 1610 entitled “Roles”, and text window 1612 entitled “Delegates” enabling user 224 to specify and select information to be viewed and/or reports to be generated covering tracking and trending information and task status based on user 224 selection elected in query application 1605. More specifically, user 224 preferably defines query application 1605 by clicking up arrow icon 1614 or down arrow icon 1616, thus scrolling through the options defined for each user 220/222/224 and previously established in FIGS. 7-9 above. Here, user 224 is an executive member and has full access to view task information and/or generate reports covering tracking and trending of task status and/or task completion for all departments, roles, delegates and the like. Based on the settings selected by user 224 for query application 1605, server system 260 returns task information from database 270 related to user 224 settings for query application 1605 and populates section 1616 with such information. Section 1616 preferably includes task information separated into column 1620 entitled “Employee” (the employees and departments, which user 224 has access to view task information), column 1622 entitled “Total” (total number of tasks assigned to an employee or department), column 1624 entitled “# Pass” (the number of tasks with a status of complete), and column 1628 entitled “% Pass” (the percentage calculated by dividing # Pass by Total (i.e., % Pass=# Pass /Total)).

Here, user 224 preferably requested a query of database 270 and server system 260 returned task information for the following departments, “finance & information 1630, sales & marketing, new home specialists, construction, TRAC solutions, executive, PVT, and purchasing.” For example, task information set forth herein for department—finance & administration 1630 preferably includes Total as 765, # Pass as 710, and % Pass as 92.18% as tracking and trending information of task status and/or completion for such department.

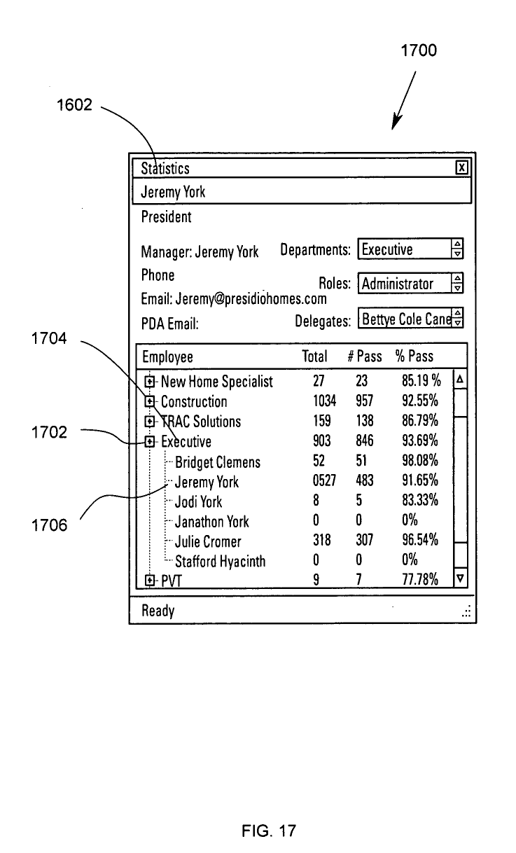

Referring to FIG. 17, there is illustrated a preferred screen shot 1700 of a user interface disclosing a template 400, wherein user 224 (shown as “Jeremy York”) preferably elects to view users 220 statistical/analysis information. More specifically, user 224 preferably clicks on icon 1702 to expand department entitled “Executive” 1704 to disclose all users 220 who are assigned to the department entitled “Executive” 1704. In response to user 224 clicking icon 1702, server system 260 preferably sends user 224 an updated screen shot 1700 preferably with window 1602 entitled “Statistics” updated based on user 224 request.

Here, user 224 preferably requested a query of database 270 and server system 260 returned task information for department entitled “Executive” 1704 and all users 220 who are assigned to the department entitled “Executive” 1704. In addition, and task information for all users 220 who are assigned to the department entitled “Executive” 1704 includes, for example, user 224 entitled “Jeremy York” 1706. For example, task information set forth herein for user 224 preferably includes Total as 527, # Pass as 483 and % Pass as 91.65% as tracking and trending information of task status and/or completion.

It is contemplated in an alternate embodiment that step 380 may include, but is not limited to additional task statistical information, such as, time to complete a task, average time to complete tasks, average time to complete tasks per a duration, number of tasks uncompleted, and the like.

Furthermore, collecting statistical information regarding task status and/or task completion provides historical information in the form of an audit trail for completed task flow or workflow processes and collecting statistical data for project, process and resource bottleneck analysis, flow optimization and automatic workload balancing and enabling dynamic statistical information such as availability and work load. Still further, system 200 and method 300 preferably provide alert and/or notice analysis to user 220/222/224. Preferably, if a task approaches or surpasses its scheduled date of completion server system 260 communicates such information to user 220/222/224. Such notice or alarm preferably is sent to the assignee of the task, the assignor of the task and to any department, role, or delegate linked to the user assigned to the task.

As such, the present system 200 and method 300 advantageously provide for negotiation of the acceptance of a task, the tracking and trending of task completion, provides statistical analysis capabilities of the task status and task completion, tracking and trending of tasks assigned to an individuals or group of individuals, sets of individuals belonging to a department or organization, tracking and trending groups of tasks making up a project, and tracking and trending of tasks across an entire organization.

Although the description given above includes specific examples of currently envisioned embodiments of the computer program, method, system, and/or apparatus, these possibilities should not be understood as limiting the scope of the present invention but rather as providing illustrations of some of the embodiments that are now preferred. Several examples of alternate embodiments are also described and various other alternatives, adaptations, and modifications may be made within the scope of the present invention. Merely listing or numbering the steps or blocks of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the claims that follow herein and their legal equivalents, rather than the examples given in the specification, should determine the scope of present invention.

What is claimed is:

1. A computer implemented method for monitoring a task, the method comprising:
receiving a first instruction from at least one user requesting access to a serve system;
determining whether said user has a matching account on said server system;
granting access to said user with said matching account; receiving a second instruction from said user requesting to log a task;
sending said user at least one template to communicate with said serve system; and
tracking a status of said task.

2. The method of claim 1, wherein said first instruction includes a user name and a password.

3. The method of claim 1, wherein said first instruction further includes a request to enroll a user.

4. The method of claim 1, wherein said first instruction further includes a user profile.

5. The method of claim 1, further comprising the step of sending a template having a list of groups available to said user to select.

6. The method of claim 5, further comprising the step of receiving a third instruction from said user wherein said user selects a group.

7. The method of claim 1, wherein said second instruction further includes a task profile.

8. The method of claim 7, wherein said task profile further includes a prioritized due date.

9. The method of claim 7, wherein said second instruction further includes a task profile assigned to a second user.

10. The method of claim 9, further comprising the step of sending a template to said user disclosing said task profile to said user.

11. The method of claim 9, further comprising the step of sending a template to said second user disclosing said task profile to said second user.

12. The method of claim 11, further comprising the step of receiving a fourth instruction from said second user wherein said second user elects to accept performance of said task.

13. The method of claim 11, further comprising the step of receiving a fifth instruction from said second user wherein said second user elects to delegate said task.

14. The method of claim 13, further comprising the step of sending a template to said second user for delegating said task.

15. The method of claim 14, further comprising the step of receiving a sixth instruction from said second user wherein said second user elects to delegate performance of said task to a third user.

16. The method of claim 15, further comprising the step of sending a template to said user disclosing said task delegation request to said user.

17. The method of claim 15, further comprising the step of sending a template to said second user disclosing said task delegation request to said second user.

18. The method of claim 15, further comprising the step of sending a template to said third user disclosing said task delegation request to said third user.

19. The method of claim 15, further comprising the step of receiving an eighth instruction from said third user requesting to negotiate the delegation of said task with said user.

20. The method of claim 19, further comprising the step of sending a template to said third user enabling said third user to negotiate said task delegation with said user.

21. The method of claim 19, further comprising the step of receiving a ninth instruction from said third user requesting to negotiate the delegation of said task with said second user.

22. The method of claim 21, further comprising the step of sending a template to said third user enabling said third user to negotiate said task delegation with said second user.

23. The method of claim 22, further comprising the step of receiving said template with a message from said third user wherein said third user is communicating said message to said second user.

24. The method of claim 18, further comprising the step of receiving a tenth instruction from said third user wherein said third user elects to accept performance of said delegated task.

25. The method of claim 12, further comprising the step of communicating task information to said users.

26. The method of claim 18, further comprising the step of communicating task information to said users.

27. The method of claim 24, further comprising the step of communicating task information to said users.

28. The method of claim 1, further comprising the step of tracking a status of said task to completion.

29. The method of claim 28, wherein said user changes said status of said task to a pending status by sending a status change to said server system.

30. The method of claim 28, wherein said user changes said status of said task to a start status by sending a status change to said server system.

31. The method of claim 28, wherein said user changes said status of said task to a work-in-progress status by sending a status change to said server system.

32. The method of claim 28, wherein said user changes said status of said task to a completed status by sending a status change to said server system.

33. The method of claim 32, further comprising the step of receiving an eleventh instruction from said user wherein said user elects to change said status of said task.

34. The method of claim 1, further comprising the step of performing task analysis on said task.

35. The method of claim 32, further comprising the step of performing task analysis on the completion of said tasks.

36. The method of claim 30, further comprising the step of performing task analysis on the non-completion of said tasks.

37. The method of claim 32, further comprising the step of performing task analysis on the completion of said tasks per said user.

38. The method of claim 30, further comprising the step of performing task analysis on the non-completion of said tasks per said user.

39. The method of claim 32, further comprising the step of performing task analysis on the completion of said tasks per a department of said users.

40. The method of claim 30, further comprising the step of performing task analysis on the non-completion of said tasks per a department of said users.

41. The method of claim 32, further comprising the step of performing task analysis on the completion of said tasks per an organization of said users.

42. The method of claim 30, further comprising the step of performing task analysis on the non-completion of said tasks per an organization of said users.

43. The method of claim 1, further comprising the step of receiving an eleventh instruction from said user wherein said user elects to perform task analysis.

44. The method of claim 1, further comprising the step of receiving a twelfth instruction from said user wherein said user elects to track a status of said task.

45. The method of claim 43, further comprising the step of communicating information of said task analysis to said user.

46. The method of claim 44, further comprising the step of communicating information of said status of said task.

47. The method of claim 43, further comprising the step of receiving a thirteenth instruction from said user wherein said user elects to generate a report of said task analysis.

48. The method of claim 47, further comprising the step of communicating information of said report to said user.

50. A system comprising:
a server connected to a network, the server receiving requests from users via the network, the server including:
at least one processor;
a database of task records; and
a memory operatively coupled to said processor, said memory containing stored programming instructions that instruct the processor to:
(a) collect task information from at least one user;
(b) store task information in one or more databases; and
(c) determine user productivity in performing one or more tasks.

51. The system of claim 50, wherein the collected task information comprises said user task completion information.

52. The system of claim 50, wherein the collected task information comprises a group of said user's task completion information.

53. The system of claim 50, wherein the collected task information comprises a group of said user's assigned to a project task completion information.

54. The system of claim 50, wherein the collected task information comprises a performance report.

55. A system for monitoring task productivity comprising: a computer processor; an input device; a display; and a memory accessible by the computer processor, the memory containing stored programming instructions that instruct the processor to:
(a) collect task information from at least one user;
(b) store task information in one or more databases; and
(c) determine user productivity in performing one or more tasks.

56. The system of claim 55, wherein the collected task information comprises said user task completion information.

57. The system of claim 55, wherein the collected task information comprises a group of said user's task completion information.

58. The system of claim 55, wherein the collected task information comprises a group of said user's assigned to a project task completion information.

59. The system of claim 55, wherein the collected task information comprises a performance report.
